(19) United States
(12) Patent Application Publication
(10) Pub. No.: US 2026/0244164 A1
(43) Pub. Date: Aug. 20, 2026

(54) TEMPORAL AUTO-TUNING A PID CONTROLLER OF A SLAVE DEVICE OF A TIME-SENSITIVE NETWORK TO A MASTER DEVICE

(71) Applicant: Schneider Electric USA, Inc., Andover, MA (US)

(72) Inventors: Alen Mehmedagic, Wilmington, MA (US); Joseph William Beckenbach, III, Somerville, MA (US)

(73) Assignee: Schneider Electric USA, Inc, Boston, MA (US)

(21) Appl. No.: 19/360,000

(22) Filed: Oct. 16, 2025

Related U.S. Application Data
(60) Provisional application No. 63/708,006, filed on Oct. 16, 2024.

(51) Int. Cl. G05B 11/42; H04J 3/06

(52) U.S. Cl. CPC G05B 11/42; H04J 3/0667

(57) ABSTRACT

A method of auto-tuning at least one PID controller corresponding to at least one slave device in a time-sensitive network to automatically synchronize the at least one slave device with a master device can include continually obtaining a master offset time and selecting, in the at least one PID controller, multiple combinations of constant values. The method can further include measuring, for each combination of constant values, a synchronization time representative of an amount of time taken by the PID controller to reduce the master offset time to a stable level and automatically applying, in the at least one PID controller, a preferred combination of values so that the at least one slave device is synchronized to the master device such that the master offset time is less than a designated master offset time threshold during operation of the at least one slave device and the master device.

### CLAIM OF PRIORITY

This application is a nonprovisional application claiming the benefit of U.S. provisional application serial number 63/708,006, filed on October 16, 2024, entitled “TEMPORAL AUTO-TUNING A PID CONTROLLER OF A SLAVE DEVICE OF A TIME-SENSITIVE NETWORK TO A MASTER DEVICE.”

### FIELD OF THE TECHNOLOGY

The present disclosure relates to the time synchronization of slave devices to master devices of a time-sensitive network (TSN), and more particularly, to temporal auto-tuning of a proportional, derivative, and integral (PID) controller of one or more respective slave devices of a TSN to a master device of the TSN.

### BACKGROUND

A proportional, derivative, and integral (PID) controller used with a time sensitive network (TSN), such as a gPTP (generalized Precision Time Protocol or IEEE 802.1AS), can be used for synchronizing the time of a slave device with the time of a master device. Manual setting of a proportional constant, a derivative constant, and an integral constant of the PID controller (“PID constants”) for achieving time synchronization usually involves a technician/engineer using trial-and-error to determine the values of the constants used by the PID controller (“PID constant values”) to continually synchronize the time kept by the slave device (e.g., the time function of the slave device) to the time kept by the master device (e.g., the time function of the master device).

### SUMMARY

When tuning, these PID constant values used by the PID controller depend on various factors, such as the environment, hardware and/or firmware of the slave device and/or master device, the operating system platforms used by the slave device and/or master device, the topology of the TSN, and/or other factors. Manual setting of the PID constant values used by the PID controller by a technician/engineer can be a laborious and time-consuming activity that requires skill and knowledge of the system within which the TSN is deployed. Thus, finding the optimal values and/or combination of values of the constants can be difficult. Ideally, the tuning process includes individually tuning each slave device in the system. Moreover, large systems can include hundreds of slave devices, causing the burden (e.g., time and resources) of tuning all slave devices in the system to increase accordingly

An example method of auto-tuning, via execution of computer-readable memory encoded with instructions, at least one proportional, derivative, and integral (PID) controller corresponding to at least one slave device in a time-sensitive network to automatically synchronize a time function of the at least one slave device with a time function of a master device is disclosed herein that can include continually obtaining a master offset time representative of a difference between the time function of the at least one slave device and the time function of the master device with the time function of the at least one slave device being dependent upon the corresponding at least one PID controller and selecting, in the at least one PID controller, multiple combinations of values of a proportional constant, a derivative constant, and an integral constant. The method can further include measuring, for each combination of values of the multiple combinations of values, a synchronization time representative of an amount of time taken by the at least one PID controller to reduce the master offset time to a stable level at or below a first designated master offset time threshold; selecting, in the at least one PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically applying, in the at least one PID controller, the preferred combination of values so that the time function of the at least one PID controller corresponding to the at least one slave device is synchronized to the time function of the master device such that the master offset time is equal to or less than the first designated master offset time threshold during operation of the at least one slave device and the master device.

An example system for auto-tuning a time function of a proportional, derivative, and integral (PID) controller of a slave device to synchronize with a time function of a master device is disclosed herein that includes the PID controller of the slave device that uses the time function that is dependent upon a combination of values of a proportional constant, a derivative constant, and an integral constant of the PID controller; the master device is in communication with the slave device and comprising the time function of the master device; and an auto-tuner in communication with the master device and the slave device with the auto-tuner having at least one computer processor and executable computer-readable instructions. The auto-tuner can be configured to continually obtain a master offset time representative of a difference between the time function of the slave device and the time function of the master device; select, in the PID controller, multiple combinations of values of the proportional constant, the derivative constant, and the integral constant; measure, for each combination of values of the multiple combinations of values, a synchronization time representative of an amount of time taken by the PID controller to reduce the master offset time to a stable level at or below a first designated master offset time threshold; select, for the PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically apply, in the PID controller, the preferred combination of values so that the time function of the PID controller corresponding to the slave device is synchronized to the time function of the master device such that the master offset time is equal to or less than the first designated master offset time threshold during operation of the slave device and the master device.

### BRIEF DESCRIPTION OF THE DRAWINGS

A more detailed description of the disclosure may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1A is a schematic block diagram of an example time-sensitive network with each slave device having an auto-tuner to synchronize the time functions of the slave devices with the time function of the master device.

FIG. 1B is a schematic block diagram of a second example time-sensitive network with the master device having an auto-tuner to synchronize the time functions of the slave devices with the time function of the master device.

FIG. 1C is a schematic block diagram of a third example time-sensitive network with an edge device (e.g., PC, telephone, mobile application, and/or other device) within the time-sensitive network having an auto-tuner to synchronize the time functions of the slave devices with the time function of the master device.

FIG. 1D is a schematic block diagram of a fourth example time-sensitive network with a cloud/remote device distant from the master device and the slave devices with the cloud/remote device having an auto-tuner to synchronize the time functions of the slave devices with the time function of the master device.

FIG. 2 is a schematic block diagram showing an example environment of the time-sensitive network.

FIG. 3A is a flow chart of an example process for automatic triggering of the auto-tuning of a slave device.

FIG. 3B is a flow chart of a second example process for manual triggering of the auto-tuning of a slave device.

FIG. 3C is a flow chart of a third example process having user selection of the preferred PID constant values along with the occurrence of a change event warranting re-tuning of the slave device.

FIG. 3D is a flow chart of a fourth example process having automatic selection of the preferred PID constant values along with the occurrence of a change event warranting re-tuning of the slave device.

FIG. 4 is a flow chart of a fifth example process for performing the auto-tuning of a slave device.

FIG. 5 is a schematic block diagram of an example device having an auto-tuner, such as a slave device, a master device, an edge device, and/or a cloud/remote device.

FIG. 6A is a graph of an example auto-tuning test with example PID constant values that do not produce a master offset time within a designated master offset time threshold.

FIG. 6B is a graph of an example auto-tuning test with example PID constant values that do not produce a synchronization time within a designated synchronization time threshold.

FIG. 6C is a graph of an example auto-tuning test with example PID constant values that produce both a synchronization time within a designated synchronization time threshold and a master offset time that is stable and within a designated master offset time.

Identical reference numerals have been used, where possible, to designate identical elements that are common to the figures. However, elements disclosed in one embodiment may be beneficially utilized on other embodiments without specific recitation. The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Moreover, where considered appropriate, reference labels have been repeated among the figures to indicate corresponding or analogous elements.

### DETAILED DESCRIPTION

Reference will now be made to the drawings wherein like reference numerals identify ‎‎‎similar structural features or aspects of the subject disclosure. For purposes of ‎‎explanation and ‎illustration, and not limitation, various example embodiments are described herein. Unless defined otherwise, all technical and scientific terms used herein have the same ‎‎‎meaning as commonly understood by one of ordinary skill in the art to which this ‎‎disclosure ‎belongs. Any methods and materials similar or equivalent to those ‎‎described herein can ‎also be used in the practice or testing of the present disclosure. ‎

It must be noted that as used herein and in the appended claims, the singular forms “a,” ‎‎‎‎“an,” and “the” include plural referents unless the context clearly dictates otherwise. ‎‎Thus, for ‎example, reference to “a stimulus” includes a plurality of such stimuli and ‎‎reference to “the signal” ‎includes reference to one or more signals and equivalents ‎‎thereof known to those skilled in the art, ‎and so forth. It is to be appreciated that the ‎‎embodiments of this disclosure as discussed below can be ‎implemented using a software ‎‎algorithm, program, or code that can reside on a computer useable ‎medium for enabling ‎‎execution on a machine having a computer processor. The machine can ‎include ‎‎memory storage configured to provide output from execution of the computer algorithm ‎‎‎or program.‎

As used herein, the term “software” is meant to be synonymous with any logic, code, or ‎‎‎program that can be executed by a processor of a host computer, regardless of whether ‎‎the ‎implementation is in hardware, firmware, or a software computer product available ‎‎on a ‎memory storage device or for download from a remote machine. The embodiments ‎‎described ‎herein include such software to implement the equations, relationships, and ‎‎algorithms described ‎above. One skilled in the art will appreciate further features and ‎‎advantages of the disclosure ‎based on the example embodiments described herein. Accordingly, ‎‎the disclosure is not to be limited by ‎what has been particularly shown and described, ‎‎except as indicated by the appended claims.

The term “master device” and “slave device” are used herein for simplicity to described an electronic device that is a time transmitter—a master device—to which an electronic device is to-be-synced as a time receiver—a slave device. Thus, a system can include multiple master devices and multiple slave devices. Moreover, one electronic device can be both a master device to one or more corresponding slave devices (i.e., can be a time transmitter to which one or multiple electronic devices are synced) while simultaneously being a slave device to one corresponding master device (i.e., can be a time receiver that is synced to another electronic device).

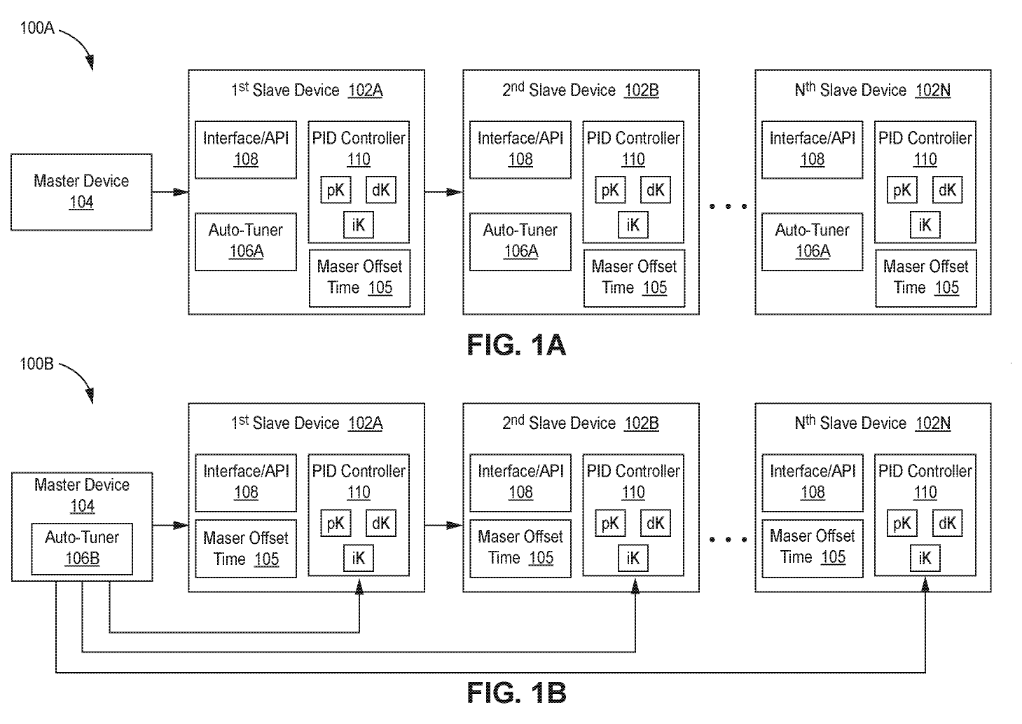

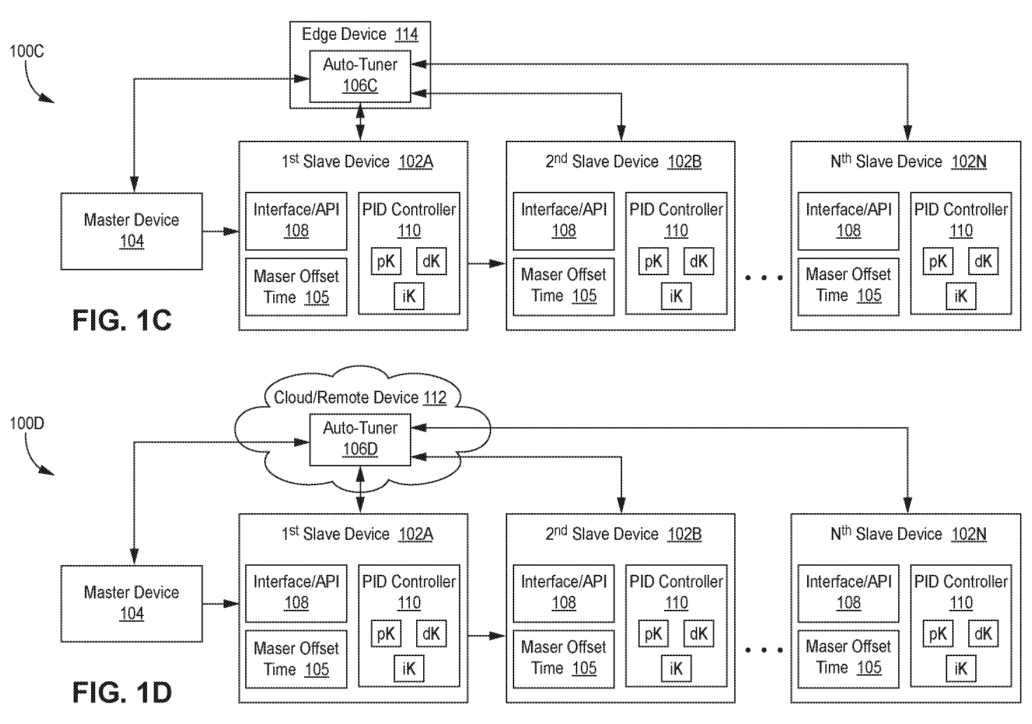

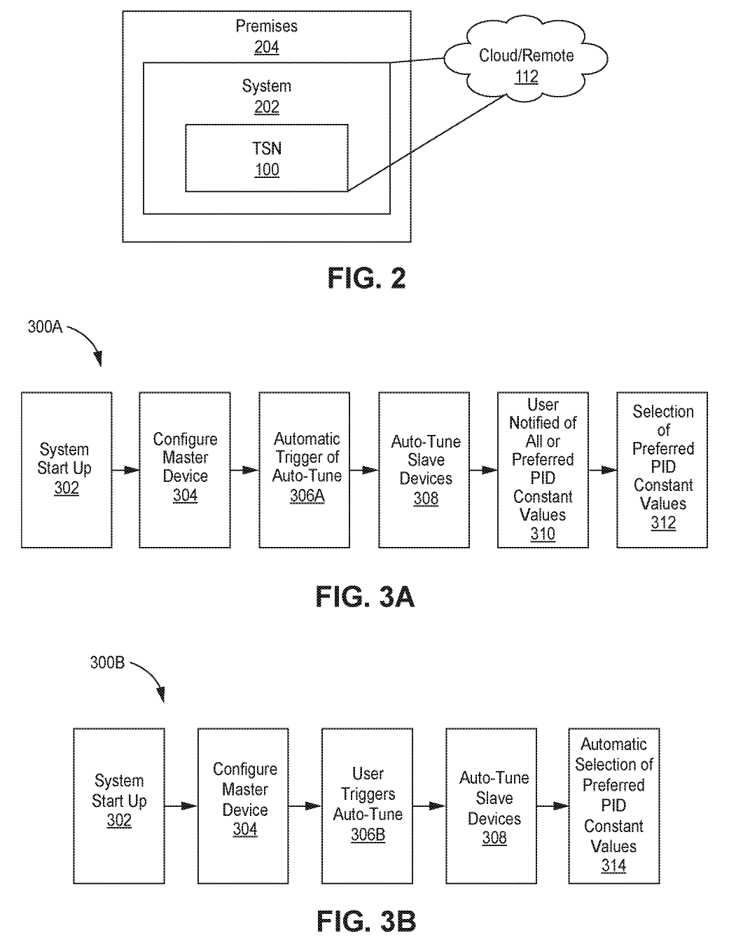

FIGS. 1A-1D and 2 are described collectively below regarding time-sensitive network (TSN) 100A, 100B, 100C, and 100D (also referred to collectively and/or individually as TSN 100). FIGS. 1A-1D show examples of different configurations of auto-tuners 106A, 106B, 106C, and 106D (also referred to collectively and/or individually as auto-tuner 106) located in and/or otherwise associated with different devices. ‎Each example TSN 100 includes master device 104 and multiple slave devices 102A, 102B, and 102N (also referred to as first slave device 102A, second slave device 102B, and Nth slave device 102N and collectively and/or individually as slave devices 102). As shown in FIG. 2, master device 104 and slave devices 102 can be any type of electrical device associated with and/or within system 202. System 202 can be any collection of components, such as an industrial system, and can be disposed within premises 204, such as a manufacturing/industrial building. For example, system 202 can be an industrial system, such as a production line, mining operation, oil and/or gas production, and/or another system. Master device 104 and slave devices 102 can be various industrial devices included in an operational technology (OT) environment, such as field devices (e.g., sensors and actuators), a process control system (PCS) (also known as an industrial control systems (ICS)) that monitors and controls industrial processes (e.g., control processors (CPs) of a distributed control system (DCS)), and/or a central operator supervisory controller, such as a supervisory control and data acquisition (SCADA) system (e.g., programmable logic controllers (PLCs) or remote terminal units (RTUs). A cloud and/or remote device 112 can be associated with and/or otherwise in communication with any of system 202 and/or TSN 100, as shown in FIG. 2, and can be distant from system 202 and/or premises 204 (e.g., off-premises).

Each slave device 102 can include, for example, interface/API 108 (e.g., an application programming interface) and PID controller 110 (which can include and/or use proportional constant pK, derivative constant dK, and/or integral constant iK to modify a time function of each slave 102 to time synchronize the slave device 102 with master device 104). Each slave device 102 can have a master offset time 105 that is obtained and/or otherwise used to time synchronize the slave device 102 with the master device 104. Shown in FIG. 1A, each slave device 102 has a corresponding auto-tuner 106A incorporated therein. However, as shown in FIGS. 1B-1D, auto-tuner 106 can be associated with master device 104 (shown in FIG. 1B), with edge device 114 (shown in FIG. 1C), and/or with cloud/remote device 112 (shown in FIG. 1D).

Alternate options are shown for deployment of an auto-tuner 106 as shown in FIGS. 1A-1D. The capabilities, configurations, and functionalities of auto-tuner 106A as shown in slave device 102 (FIG. 1A), auto-tuner 106B as shown in master device 104 (FIG. 1B), auto-tuner 106C as shown in edge device 114 (FIG. 1C), and/or auto-tuner 106D shown in cloud/remote device 112 (FIG. 1D) can be the same and are described collectively herein as auto-tuner 106. Thus, auto-tuner 106 can be located at, within, adjacent to, incorporated into, and/or otherwise associated with any component. For example, auto-tuner 106 can be in a cloud and/or remote environment (e.g., cloud/remote device 112) distant from master device 104 and slave devices 102 (i.e., distant from premises 204). In another example, auto-tuner 106 can be on/within premises 204 of system 202 and/or TSN 100 by being incorporated into one or multiple of edge device 114, master device 104, and/or slave devices 102.

Each of auto-tuners 106 can be configured to periodically and/or continually obtain, via API 108, the current master offset time 105 and determine optimized values for the PID constants for a corresponding slave device 102. Additionally and/or alternatively, each of auto-tuners 106 can be configured to set, via API 108, the PID constant values in PID controller 110 of the corresponding slave device 102 with the preferred/optimized PID constant values. With respect to FIG. 1C, the on-premises device 114 within which auto-tuner 106 can be deployed can be, for example, an engineering toolset, a smartphone using an application, and/or an edge device, without limitation. With respect to FIG. 1D, the off-premises cloud/remote device 112 within which auto-tuner 106 can be deployed can be, for example, a server that is located remote from premises 204 and may or may not be deployed in an Internet accessible cloud. At least a portion of one or more networks used by off-premises cloud/remote device 112 to access slave device 102 can be external to premises 204. Remote auto-tuning can be performed by off-premises cloud/remote device 112 through the one or more networks using, but not limited to, management protocols such as NETCONF™ and SNMP®.

Certain embodiments, such as shown in FIGS. 1A and 1B, can use proprietary configurations in which auto-tuner 106 is installed in slave devices 102 and/or master device 104. In other embodiments, auto-tuner 106 can be installed in an engineering tool that can operate with any slave device 102 and/or master device 104, whether or not they include an auto-tuner 106. The configurations, capabilities, and functionalities of slave device 102, master device 104, and auto-tuner 106 are described below and can be applicable to any of the components and configurations shown and described herein.

Application programming interface (API) 108 can be disposed in each slave device 102. Each slave device 102 includes PID controller 110 that can be configured with a combination of PID values: proportional constant pK, derivative constant dK, and integral constant iK. It is noted that throughout this disclosure, reference to PID controller 110 can be substituted with a PI controller in which the derivative constant dK is not used such that the PI controller only uses the proportional constant pK and integral iK to synchronize the time function of slave device 102 to the time function of master device 104. In such cases, reference to the derivative constant and associated processing can be disregarded. In certain examples, reference to PID controller 110 can be substituted with a PD controller in which the integral constant iK is not used, such that the PD controller only uses the proportional constant pK and derivative constant dK to synchronize the time function of slave device 102 to the time function of master device 104. In such cases, reference to the integral constant iK and associated processing can be disregarded. Further, each slave 102 stores a master offset time 105 value. Auto-tuner 106 can read, measure, calculate, analyze, and/or otherwise identify master offset time 105 and determine the combination of PID constant values for/of PID controller 110 using and/or with aid from interface/API 108.

In one example, PID controller 110 is a generalized precision time protocol (gPTP) PID controller as defined by IEEE 802.1AS specifications. PID controller 110 can be a PID controller that operates within and/or on TSN 100 to provide time synchronization between slave device 102 and master device 104. PID controller 110 can be configured to adjust an algorithm (using changes to proportional constant pK, derivative constant dK, and/or integral constant iK) that modifies the clock of the corresponding slave device 102 to adjust the time function (e.g., the time kept by the clock) to more closely match the time function of master device 104.

In TSNs that use gPTP, a master device can periodically on a continual basis (e.g., every 125 milliseconds) send sync messages to slave devices 102 that include the current time of master device 104. Each slave device 102 can then, using auto-tuner 106, synchronize the time of the slave device 102 with the time of master device 104 using PID (or PI or PD) controller 110. PID controller 110 uses the current master offset time 105, which is representative of a difference between the time function of slave device 102 and the time function of master device 104, to adjust the clock frequency of PID controller 110 with a goal of making the master offset time 105 equal to zero. Since the clock (e.g., time function) of master device 104 and the clock (e.g., time function) of slave device 102 are derived from crystal oscillators that do not oscillate at the exact same frequency and are not consistent, each PID controller 110 for each slave device 102 can continually make adjustments to the time function to maintain time synchronization with master device 104. The values of the PID constants that are used in an algorithm of PID controller 110 to modify the time function of PID controller 110 to synchronize the time with master device 104 affect the performance of the synchronization, including the time for initial synchronization (e.g., the synchronization time), the jitter (range of minimum and maximum master offset time 105) after synchronization is achieved and the master offset time 105 is at a stable level (i.e., steady state), and/or the speed and behavior of synchronization recovery to the stable level after loss of synchronization.

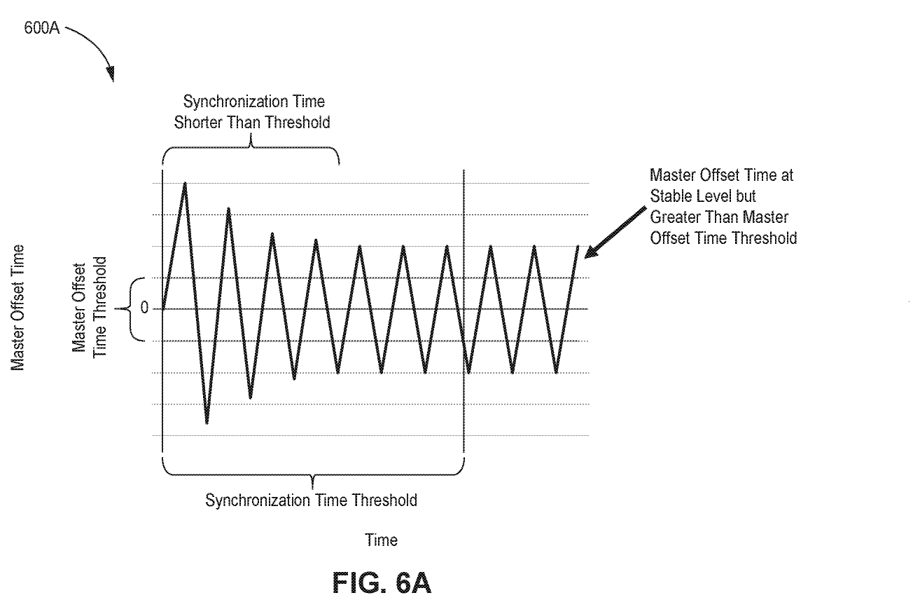

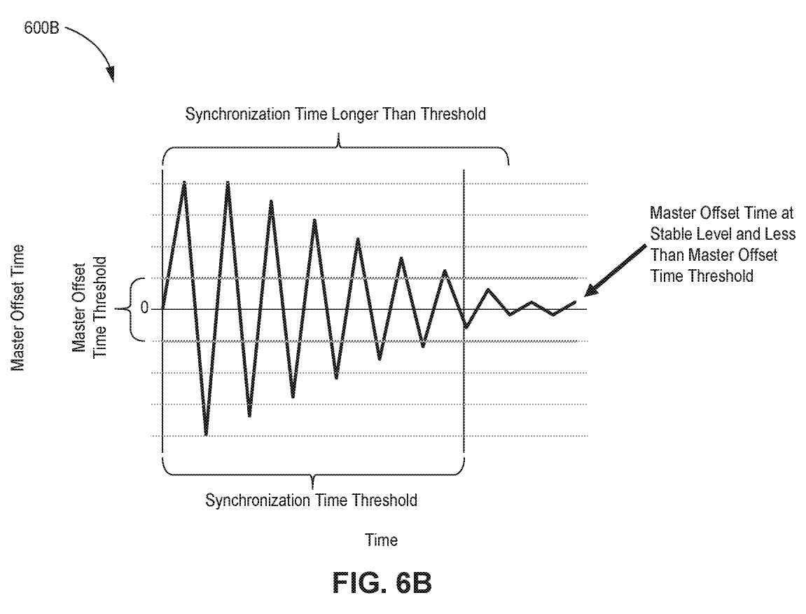

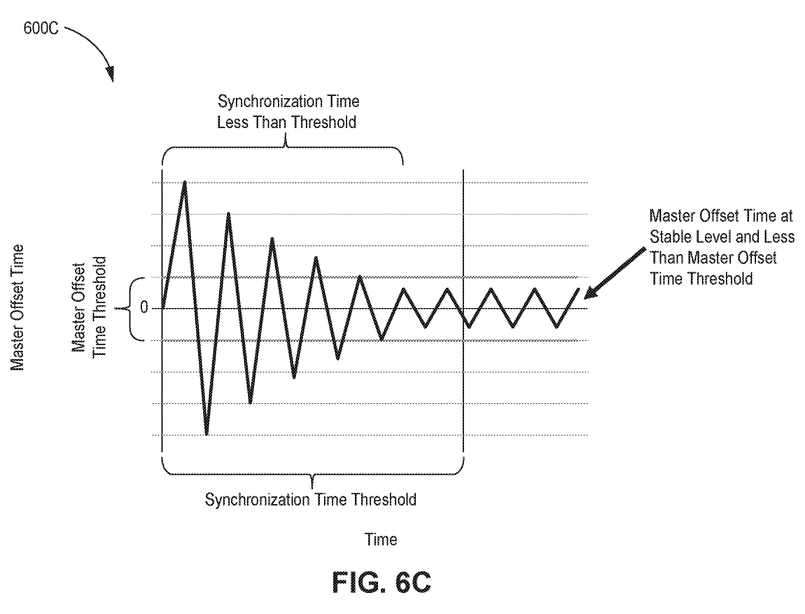

A master offset time at a stable level (also referred to here as at a steady state and/or a master offset time that has stabilized) is when the master offset time remains within a particular range (e.g., does not exceed 20 nanoseconds) for an extended period of time (e.g., for multiple minutes and/or does not appear to be deviating from a predictable oscillation (see FIGS. 6A-6C for examples)). Thus, the master offset time at a stable level can include fluctuations in the master offset time, but those fluctuations are within a predictable range and follow a predictable pattern. Thus, one goal of auto-tuning a PID controller 110 is to reduce the master offset time to a stable level in which the master offset time can fluctuate but does not exceed a designated master offset time threshold for an extended period of time.

Manual tuning of the PID constant values (e.g., the manual determination of the constant values pK, dK, and/or iK) is time consuming, requiring engineering skill and knowledge of the system in which TSN 100 is deployed, and can result in a determination of PID constant values that do not provide the most optimal tuning (e.g., do not provide a shortest amount of synchronization time and/or a smallest amount of master offset time 105).

Synchronization recovery can occur after a disturbance (e.g., a jump of the master offset time and/or a sudden change in the master offset time that exceeds a threshold). Recovery can change depending on the in-use and potentially newly determined/introduced PID constant values pK, dK, and/or iK. Experimentation results (e.g., the results of the tests to determine the pK, dK, and/or iK as described below) can show that changing the proportional constant pK, derivative constant dK, and/or integral constant iK can change the speed of synchronization recovery. Changes to one, multiple, or all of the PID constant values pK, dK, and iK can affect not just the speed of synchronization recovery, but also the behavior of the recovery. For example, changes to the proportional constant pK may cause a recovery having a type of zig-zag shape when graphed on a master offset time over/versus time curve (shown as examples in FIGS. 6A-6C), whereas changes to the integral constant iK may cause a recovery having more of a cone/wave shape of the synchronization time when graphed on a master offset time over/versus time curve.

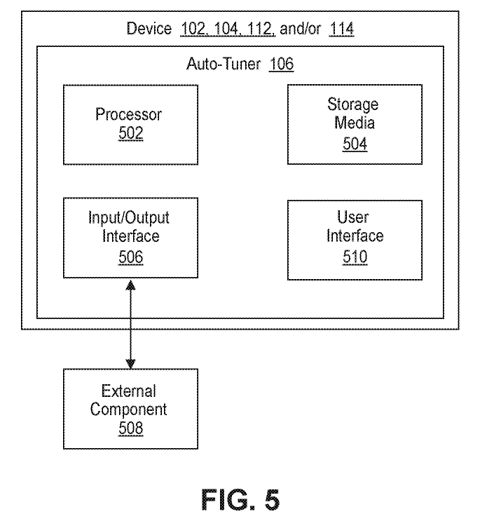

Auto-tuner 106 can be configured to automatically find a combination of preferred PID constant values by monitoring the master offset time over/versus time while modifying each of the PID constant values during auto-tuning to determine the combinations of values that satisfy the designated conditions, such as a synchronization time that is less than a designated synchronization time threshold and/or a master offset time 105 (when at a stable level of jitter) that is less than a designated master offset time threshold. The master offset time 105 can be the temporal distance from the time function of the slave device 102 to the time function of master device 104, which can be caused by various errors/differences in the hardware, firmware, software, etc. of master device 104 and/or slave device 102. Thus, one goal of auto-tuner 106 is to account for the errors/differences by modifying the PID constant values so that the time function of the slave device 102 closely mirrors, matches, and/or otherwise synchronizes the time of slave device 102 to the time as kept by master device 104. Automation of the auto-tuning by, for example, auto-tuner 106 refers to the automatic determination (once triggered either manually by a user and/or automatically in response to, for example, startup of TSN 100 and/or another event) of a preferred combination of PID constant values that can be used by PID controller 110 to reduce the master offset time 105 by adjusting the time function of slave device 102. The PID constant values can be automatically set in PID controller 110 of slave device 102, can be provided as a recommendation to a user for implementation in/with PID controller 110 (via, for example, user interface 510 shown in FIG. 5), can be provided as a recommendation for other slave devices 102, and/or can be stored for future use. As described herein, the term “user” can include a human operator or another individual and/or a computer processor/system (e.g., auto-tuner 106, a large language model/artificial intelligence system, a neural network, and/or a computer application/program) configured to automatically perform tasks and/or provide inputs, such as selections of settings and/or various options/recommendations.

The tuning of slave devices 102 by auto-tuners 106 can be triggered manually or automatically during initial set up of TSN 100, master device 104, and/or each slave device 102 and can be configured to tune slave device 102 once and/or continually to determine optimal and/or preferred PID constant values pK, dK, and/or iK. In certain embodiments, auto-tuner 106 eliminates the need for manually testing different values for the PID constant values and eliminates guess work and/or trial-and-error used in the manual tuning process. The automation of tuning of PID controllers 110 allows for the testing of the PID constant values at more granular increments (e.g., allows for the adjustability of the step value as described below) for finding optimal/acceptable PID constant values in comparison to the manual method.

The auto-tuning process, as performed by, for example, auto-tuner 106, can use various tuning strategies, methods, tuning strategy configuration tables, etc. for determining an optimal, acceptable, and/or preferrable combination of PID constant values pK, dK, and/or iK. An example of the procedure for tuning PID controller 110 (e.g., for determining the preferred combination of PID constant values pK, dK, and iK) is described below. However, other tuning procedures can include using a strategy configuration table, a Ziegler-Nicoles tuning method, an Astrom-Hagglund tuning method, and/or a Cohen-Coon tuning method. One example procedure is as follows:
1. Continually record/measure the master offset time 105 during at least one of the following conditions: nominal operation (effect of parameters/constants on the stable system); synchronization time from startup of master device 104, slave device 102, and/or TSN 100; link loss/restoration; a jump of time and/or functionality of master device 104; and TSN 100 and/or another system on which master device 104 and slave devices 102 are running is busy (e.g., processes other than time synchronization are consuming large amount of processing and/or network capacity).
2. For one or each of the conditions above:
   a) Set the value of proportional constant pK to 1.0, the value of derivative constant dK to 0, and the value of integral constant iK to 0.
   b) Increase the value of proportional constant pK by a step value (e.g., increase pK by 0.1 for each test/iteration) to generate combinations of PID constant values while measuring, for each combination of PID constant values (e.g., pK=1.3, dK=0, and iK=0), the synchronization time until a value of proportional constant pK renders a combination of PID constant values that results in the synchronization time that is greater than a designated test synchronization time threshold (e.g., synchronization time is greater than five minutes).
   c) Reset the value of proportional constant pK to 1.0 while the values of derivative constant dK and integral constant iK remain at 0.
   d) Decrease the value of proportional constant dK by the step value (e.g., decrease pK by 0.1 for each test/iteration) to generate combinations of PID constant values while measuring, for each combination of PID constant values (e.g., pK=0.6, dK=0, and iK=0), the synchronization time until the value of proportional constant pK is 0 or a value of proportional constant pK renders a combination of PID constant values that results in the synchronization time that is greater than the designated test synchronization time threshold.
   e) Set the value of proportional constant pK to a preferred proportional constant value pK that renders the fastest synchronization time (e.g., the fastest synchronization time is 14 seconds with pK=1.6, dK=0, and iK=0 so proportional constant pK is set to 1.6) while the master offset time is at a stable level that is the smallest amount of time (e.g., stabilized at a maximum master offset time of 17 nanoseconds).
   f) Repeat steps b through d above (to determine/test the value of derivative constant dK) with the value of proportional constant pK set at the preferred proportional constant value pK (determined in step e (e.g., pK=1.6)), the value of derivative constant dK initially being set to 1.0, and the value of integral constant iK being set to 0.
   g) Set the value of derivative constant dK to a preferred derivative constant value dK that renders the fastest synchronization time (e.g., the fastest synchronization time is 11 seconds with pK=1.6, dK=0.8, and iK=0 so derivative constant dK is set to 0.8) while the master offset time is at a stable level that is the smallest amount of time (e.g., stabilized at a maximum master offset time of 15 nanoseconds).
   h) Repeat steps b through d above (to determine/test the value of integral constant iK) with the value of proportional constant pK set at the preferred proportional constant value pK (determined in step e (e.g., pK=1.6)), the value of derivative constant dK set at the preferred derivative constant value dK (determined in step g (e.g., dK=0.8)), and the value of integral constant iK initially being set to 1.0.
   i) Set the value of integral constant iK to a preferred integral constant value iK that renders the fastest synchronization time (e.g., the fastest synchronization time is 8 seconds with pK=1.6, dK=0.8, and iK=2.2 so integral constant iK is set to 2.2) while the master offset time is at a stable level that is the smallest amount of time (e.g., stabilized at a maximum master offset time of 7 nanoseconds).

This procedure can be repeated in a loop while setting each PID constant value as the immediately preceding preferred PID constant value (e.g., steps b through d above for the value of proportional constant pK with the value of proportional constant pK being initially set to 1.0, the value of derivative constant dK set at the preceding preferred value dK=0.8, and the value of integral constant iK set at the preceding preferred value iK=2.2) to potentially identify better combinations of PID constant values. Additionally and/or alternatively, the procedure can be repeated multiple times with each loop using a different step value in steps b and d to provide more or less granularity to the testing of the combinations of PID constant values. The procedure described above can be used to select/generate and test many combinations of PID constant values and test those values by measuring how each combination of PID constant values causes the master offset time to react with a goal of identifying the combination of PID constant values that results in the shortest synchronization time and the smallest master offset time. The procedure can include rebooting the system or rebooting the gPTP process in between testing different combinations of PID constant values or the procedure/system can test different constants while running, without rebooting.

Graphs of the test results can be formulated live and/or after the test/auto-tuning, such as example graphs shown in FIGS. 6A-6C, to display the master offset time over/versus time over the period of one test of one combination of PID constant values and/or over the period of multiple or all tests of multiple combinations of PID constant values. The graphs (and other data) can provide and/or otherwise display one, multiple or all combinations of PID constant values and/or the optimal, acceptable, and/or preferred combination of PID constant values and allow for the user to select which combination of PID constant values to implement, apply, and/or otherwise set in PID controller 110 to adjust the time function of slave device 102. Criteria for selecting a combination of the PID constant values can be customizable, such as based on tradeoffs between a synchronization time and master offset time 105 (at a stable level).

As mentioned above, FIGS. 6A-6C are graphs 600A-600C of master offset time over/versus time for example auto-tuning tests using example PID constant values. Graphs 600A-600C are three instances of results from the testing of three different combinations of PID constant values. For example, the combinations of PID constant values producing graphs 600A-600C can be selected and tested using the procedure described above. FIGS. 6A-6C each show a graph corresponding to only one combination of PID constant values, but other graphs can show multiple combinations of PID constant values either simultaneously (e.g., the curves overlap) and/or in series (e.g., the curve for one combination of PID constant values follows the curve for another combination of PID constant values such that multiple curves are shown along a line from left to right). Graphs showing the results of auto-tuning/testing of combinations of PID constant values can have other configurations with those configurations being customized by, for example, a user.

Graph 600A of FIG. 6A shows the auto-tuning/test results for one slave device/PID controller from the trial of PID constant values pK, dK, and iK that resulted in a synchronization time (e.g., the time PID controller 110 takes after applying the combination of PID constant values for the master offset time to reach a stable level) that is less than the designated synchronization time threshold but that resulted in a master offset time (at a stable level) that is greater than the designated master offset time threshold. The synchronization time threshold and/or the master offset time threshold can be designated by a user (and/or automatically specified by auto-tuner 106) to be any threshold values that reflect user preferences. For example, the synchronization time threshold can be set at twenty seconds such that preferred combinations of PID constant values are required to result in a synchronization time of the master offset time to a stable level to be less than or equal to twenty seconds. Similarly, for example, the master offset time threshold can be set at ten nanoseconds such that preferred combinations of PID constant values are required to result in the master offset time to be at a stable level that is equal to or less than ten nanoseconds. However, because a smaller master offset time generally causes the synchronization time to be greater (and a short synchronization time generally causes the master offset time to be greater), a tradeoff/balance between the designations/selections of the synchronization time threshold and the master offset time threshold may need to be accommodated. Because the combination of PID constant values results in the stable level of the master offset time being greater than the master offset time threshold, the combination of PID constant values in graph 600A is not a preferred combination of PID constant values and likely would not be acceptable/optimal.

Similarly, graph 600B of FIG. 6B shows another example of auto-tuning results from the same slave device/PID controller (as graph 600A) but for another trial of a different combination of PID constant values pK, dK, and iK that resulted in a synchronization time that is greater than the designated synchronization time threshold even though the master offset time (at a stable level) is less than the designated master offset time threshold. Thus, while the combination of PID constant values resulted in an acceptable master offset time, the combination of PID constant values resulted in the PID controller 110 taking too long to stabilize the master offset time, so the combination of PID constant values in graph 600B is not a preferred combination of PID constant values and likely would not be acceptable/optimal.

Graph 600C of FIG. 6C shows another example of auto-tuning results from the same slave device/PID controller (as graphs 600A and 600B) but for another trial of a different combination of PID constant values pK, dK, and iK that resulted in a synchronization time that is less than the designated synchronization time threshold along with a master offset time (at a stable level) that is less than the designated master offset time threshold. The combination of PID constant values corresponding to graph 600C results in a time function that satisfies both designated criteria: a satisfactory synchronization time after applying the combination of PID constant values and a master offset time that is less than (i.e., within) the acceptable error/deviation. Thus, the combination of PID constant values in graph 600C is a preferred combination of PID constant values and likely would be acceptable. However, even after the preferred combination of PID constant values is determined/identified, the procedure set out above (and/or other processes) may still continue to find a combination of PID constant values that have an even shorter synchronization time and/or a smaller master offset time.

Moreover, auto-tuner 106 can have a “self-calibrate” option in which auto-tuner 106 auto-tunes the PID constant values instead of manual configuration of the PID constant values. The auto-tuning process/procedure performed by auto-tuner 106 can optimize for both minimizing the amount of master offset time and minimizing an amount of time to achieve time synchronization (e.g., the synchronization time) between slave device 102 and master device 104.

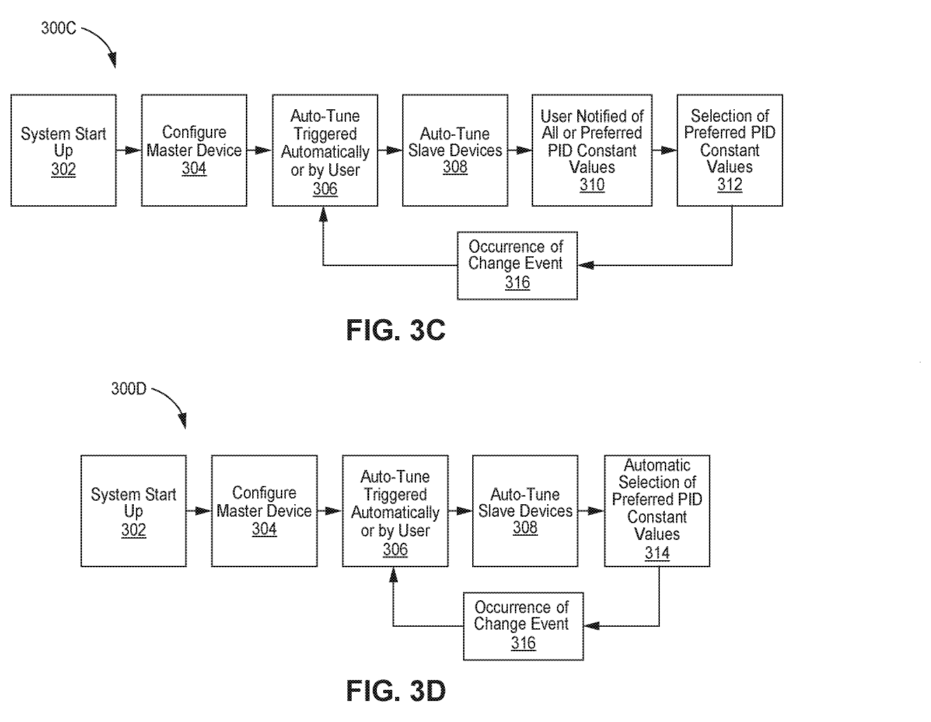

FIGS. 3A-3D show various flow charts of example processes for triggering the auto-tuning of a slave device and/or implementing a preferred combination of PID constant values in/by the PID controller. Processes 300A-300D can be performed by any apparatuses or systems having any components, capabilities, configurations, and/or functionalities suitable for performing processes 300A-300D. Additionally, processes 300A-300D can include other steps not expressly disclosed herein and can include performing the disclosed steps in any order, multiple times, concurrently, and/or sequentially as is preferred or necessary. Similarly named and numbered steps in processes 300A-300D can be performed similarly and/or can have similar configurations, capabilities, and/or functionalities described herein. Additionally and/or alternatively, as described below, one, multiple, or all steps of processes 300A-300D can be configured to be performed automatically in response to, for example, access to or reception of information/data needed to perform that particular step, the performance of the previous step, the availability of resources needed to perform that particular step, a schedule detailing when that particular step is to be initiated or completed, or any other triggering events or instructions. Alternatively, one, multiple, or all steps can be initiated and/or performed manually by a user.

In certain embodiments, when the configuration of master device 104 is ready, auto-tuning is ready to be performed by auto-tuner 106 (depending on where auto-tuner 106 is deployed/located). The auto-tuning by auto-tuner 106 (meaning any of auto-tuners 106A, 106B, 106C, 106D) can be triggered automatically in response to startup or another event and/or manually by a user. The preferred combination(s) of PID constant values determined for each slave device 102 can be communicated to a user, for example, via user interface 510 (e.g., a graphical user interface (GUI) or human-machine interface (HMI)) of the device/component that auto-tuner 106 is associated with (device 102, 104, 112, and/or 114) and/or via slave device 102. Additionally and/or alternatively, the preferred combination(s) of PID constant values can be transmitted and/or displayed along with an identity of the corresponding slave device 102 alone or together with other preferred combination(s) of PID constant values corresponding to other slave devices 102. Moreover, the preferred combination(s) of PID constant devices can be stored (and/or the user can designate storage) for future use by the corresponding PID controller 110 of the slave device 102 and/or by other PID controllers 110 of other slave devices 102.

Processes 300A-300D can each begin with system startup 302. System startup can be any of power up of system 202 or a component of system 202 (which can be included within TSN 100 or not included in TSN 100). After startup, the master device can be configured (step 304) to set up, activate, and/or otherwise implement the time function of the master device (e.g., the clock of the master device begins and/or continues to track time). In other processes, the master device is preconfigured such that step 304 is not necessary and/or abbreviated.

Next, processes 300A-300D can each include triggering the auto-tuning of each slave device (step 306). In process 300A, the auto-tuning is triggered automatically (step 306A) in response to, for example, the startup of the system and/or the completion of configuration of the master device. In process 300B, the auto-tuning is triggered manually (step 306B) by a user. Auto-tuner 106 and/or the system generally can be configured to prompt a user (e.g., via user interface 510) to manually trigger the auto-tuning of one or multiple slave devices. In processes 300C and 300D, auto-tuning is triggered either automatically in response to an event or manually by a user (generally, step 306). In processes 300C and/or 300D, whether auto-tuning is triggered manually or automatically can be specified by a user before startup (step 302) and/or at any point before or during processes 300C and/or 300D.

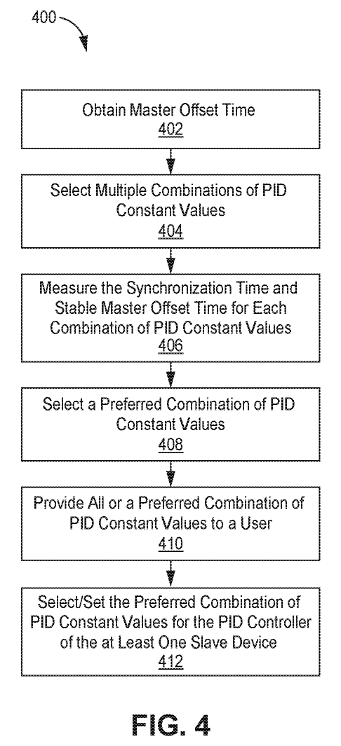

Processes 300A-300D can each include auto-tuning one, multiple, or all slave devices (step 308). The auto-tuning of each slave device can be performed using any procedure to select, generate, and/or otherwise identify one or multiple combinations of PID constant values that can be implemented in/by the corresponding PID controller to modify the time function (e.g., the tracking of the time of the corresponding slave device) to reduce the master offset time. One example process of auto-tuning is described with regards to FIG. 4 below.

After one or multiple combinations of PID constant values are identified (e.g., auto-tuning of each slave device in step 308), processes 300A-300D can include alternative steps. In processes 300A and 300C, a user is notified of all combinations of PID constant values and/or of one or multiple preferred combinations of PID constant values (step 310). The notification can be in any format and/or configuration. For example, each graph of the results of testing each combination of PID constant values can be provided to the user, such as the example graphs 600A-600C shown in FIGS. 6A-6C, respectively. In another example, the synchronization times and/or corresponding master offset times (at a stable level and/or whether the master offset times ever stabilized) can be provided in a table and/or another configuration. In a third example, a user is provided/notified of only the combinations of PID constant values that both have synchronization times within the designated synchronization time threshold and master offset times within the designated master offset time threshold (e.g., the preferred combinations of PID constant values). In a fourth example, a user is provided/notified of only the most preferred combination of PID constant values that rendered the shortest synchronization time along with the smallest master offset time.

Next, processes 300A and 300C include the selection of one preferred combination of PID constant values (step 312). This can be performed, for example, via user interface 510 with the system (e.g., slave 102, API 108, and/or PID controller 110) then automatically implementing the selected combination of PID constant values in the PID controller. Alternatively, a user can manually modify the PID constant values in the PID controller depending upon and/or to equal the preferred combination of PID constant values.

Alternative to processes 300A and 300C, processes 300B and 300D can include the automatic selection and/or implementation of a preferred combination of PID constant values (step 314). In some embodiments, processes 300B and/or 300D can include notifying the user of one, multiple, or all combinations of PID constant values (step 310) and then selecting/implementing a preferred combination, or processes 300B and/or 300D can include skipping the notification to the user and simply implementing one of the preferred combinations (a combination of PID constant values that render a synchronization time that is shorter than the designated synchronization time threshold along with a master offset time that is smaller than the designated master offset time threshold) or the best combination (the one most preferred combination of PID constant values that renders the shortest/fastest synchronization time and the smallest master offset time). The automatic selection/implementation of the combination of PID constant values can be performed by any component, such as API 108, PID controller 110, processor 502, user interface 510, and/or slave device 102 generally.

After selection/implementation of the preferred PID constant values (step 312), the slave devices can function as intended with a time function that keeps time similar to the time function of the master device. However, events within system 202 may occur that can alter any of system 202, TSN 100, master device 104, and/or slave device 102 to change, destabilize, throw off, and/or otherwise increase the master offset time. Thus, processes 300C and 300D show the occurrence of a change event (step 316). The change event can be anything that alters the master offset time and/or the synchronization time, such as a communication disruption and/or restoration between master device 104 and slave device 102; a disturbance (including a change) in system 202, an environment of system 202, master device 104, or slave device 102; a topology change of TSN 100, master device 104, system 202, and/or slave device 102; a hardware, software, and/or firmware change to system 202, TSN 100, master device 104, and/or slave device 102; and/or another type of event. In response to the occurrence of a change event (step 316) processes 300C and/or 300D can include reperforming the processes beginning at the automatic and/or manual triggering of the auto-tuning of one, multiple, or all slave devices (step 306) so that the slave device is auto-tuned (step 308) and the preferred PID constant values are reidentified and potentially reselected/reimplemented (step 312 and/or step 314).

Processes 300A-300D can have other steps, such as those in another process, other than those shown in corresponding FIGS. 3A-3D, respectively, depending on the preferences of the user and/or other considerations. Thus, processes 300A-300D are highly customizable to ensure one or multiple slave devices remain in (or quickly return to) time synchronization with the master device after startup and/or after the occurrence of an event that could influence the time synchronization.

FIG. 4 is a flow chart of an example process 400 for performing auto-tuning of a slave device, for example, via auto-tuner 106. In certain embodiments, process 400 is a fully computer-implemented process where all steps are performed automatically by a computer. Additionally and/or alternatively, as described herein, one, multiple, or all steps of processes 400 can be configured to be performed automatically, for example, by a computer, in response to, for example, access to or reception of information/data needed to perform that particular step, the performance of the previous step, the availability of resources needed to perform that particular step, a schedule detailing when that particular step is to be initiated or completed, or any other triggering events or instructions. Alternatively, one, multiple, or all steps of process 400 can be initiated and/or performed manually by a user. Thus, in certain embodiments, process 400 can be implemented as a partially computer-implemented process, wherein at least one operation may be performed by a user but all other steps are performed automatically. Further, in some embodiments, the process can be implemented as a fully manual process. As described in process 400, auto-tuner 106 can be deployed, located, and/or otherwise associated with any device, such as master device 104, slave device 102, edge device 114, and/or cloud/remote device 112.

‎ Process 400 is an example process demonstrating ‎implementation of the various example embodiments. It is noted that the order of ‎operations/steps shown in FIG. 4 is not required, so in principle, the various operations may ‎be performed out of the illustrated order. Also, certain operations may be skipped, ‎different operations may be added or substituted, some operations may be performed in ‎parallel instead of strictly sequentially, or selected operations or groups of operations ‎may be performed in a separate application following the embodiments described herein. ‎

Process 400 can begin by obtaining the master offset time (step 402), which is a difference between a time function of a slave device and a time function of the master device. The master offset time can be continuously obtained, obtained periodically but on a continual schedule (e.g., every 125 milliseconds), and/or obtained once or a small number of times. In certain embodiments, the master device and the one or more slave devices use gPTP. The master offset time can be calculated by auto-tuner 106, API 108, and/or other components depending upon the time function of the master device and the time function of the slave device. In configurations in which auto-tuner 106 is located within edge device 114 and/or cloud/remote device 112, step 402 may include communicating the time function of the master device and/or the slave device to auto-tuner 106.

Next, process 400 can include selecting one or multiple combinations of PID constant values to test (step 404). At step 404, different combinations of PID constant values can be set in the PID controller of the slave device with the combinations of PID constant values including proportional constant pK, derivative constant dK, and/or integral constant iK. The multiple combinations of PID constant values that are to be tested can be selected via any procedure, including the procedures described above. In certain embodiments, the granularity by which the different combinations of values are selected (i.e., the step value by which each PID constant value is changed to select/generate a new combination of PID constant values for testing) is customizable and user selectable. For example, in the procedure described above, one PID constant value is changed by 0.1 during the testing of each combination of PID constant values. However, other configurations can change each PID constant value by 0.05, 0.02, 0.5, and/or another step value depending upon the desires of the user and/or the length of time allowed for auto-tuning.

For each combination of PID constant values selected/set in step 404, process 400 can include measuring the synchronization time and master offset time (at a stable level) that results from applying that combination of PID constant values to the PID controller (step 406). As described above, the synchronization time can be representative of the amount of time taken by the PID controller to reduce the master offset time to a stable level. Also measured can be the master offset time at that stable level. Thus, step 406 can include measuring the time the PID controller takes to reduce the master offset time to a stable level that is at or less than a designated master offset time threshold (i.e., a master offset time that is acceptable to the user). In some instances, the time the PID controller takes to reduce the master offset time to a stable level that is at or less than a designated master offset time threshold may be infinite (or near infinite) because either stabilization of the master offset time does not occur (or does not occur within a designated maximum allowable stabilization/synchronization time) or the master offset time (at a stable level) is greater than the master offset time threshold (e.g., the master offset time has an error that is greater than that which is acceptable to the user). The testing and measuring for one or multiple combinations of PID constant values can be performed concurrently and/or sequentially to record the synchronization time and/or master offset time resulting from each combination of PID constant values.

The values for the designated synchronization time threshold (i.e., the maximum acceptable amount of time the PID controller takes to reduce the master offset time to a stable level) and/or for the designated master offset time (i.e., the maximum acceptable master offset time when at a stable level) can be designated by a user depending on a variety of factors, including the need for the quick availability of the slave device upon startup (so thus the synchronization time is desired to be short) and/or the need for accuracy regarding the master offset time (so thus the master offset time is desired to be small). Additionally, the length of time the auto-tuning will allow the PID controller to stabilize the master offset time can be designated, which is labeled/specified herein as a second/test synchronization time threshold. For example, a user can designate that the test of one combination of PID constant values should be abandoned if, after applying that combination of PID constant values to the PID controller, the master offset time does not stabilize after five minutes (so thus the synchronization time is greater than the five minute designated test synchronization time threshold).

Process 400 can include identifying and/or otherwise selecting a preferred combination of PID constant values (step 408) that meets the designated results set by the user and/or that has the shortest synchronization time and/or smallest master offset time. The preferred combination of PID constant values can be identified and/or otherwise selected depending on other criteria. The identification of the preferred combination of PID constant values can be performed automatically by any of the components of auto-tuner 106 (e.g., processor 502) and/or other components and/or can be selected manually by a user via review of the results of the auto-tuning/testing of each combination of PID constant values. In process 400, the identification/selection of the preferred combination of PID constant values (step 408) is performed automatically by auto-tuner 106 (e.g., via processor 102).

In certain embodiments, the one or more satisfaction criteria for the combination of PID constant values can be user selectable. If multiple acceptable thresholds of master offset time are used, the selection can include a tradeoff of selecting an acceptable/designated master offset time threshold and an acceptable/designated synchronization time threshold that may not each be the best, but together provide an acceptable result for operation of the system (e.g., an acceptable master offset time for the slave device that allows for operation of system 202).

Process 400 can include providing one, multiple, or all tested combinations of PID constant values and/or the preferred combinations of PID values to a user (step 410). As described above, this can be via any tables, graphs, and/or other processes/configurations to allow a user to identify which combinations of PID constant values are desirable. Some configurations of process 400 may not include step 410 and instead the preferred combination of PID constant values is automatically selected by, for example, auto-tuner 106 and/or another component.

Finally, the preferred combination of PID constant values can be selected for and/or implemented in the PID controller of the slave device (step 412). Setting the proportional constant pK, derivative constant dK, and/or integral constant iK in the PID controller can modify an algorithm used by the PID controller to keep track of time (e.g., the time function of the slave device) such that the time remains within the designated master offset time threshold as compared to the time as kept by the master device. The setting of the PID constant values (step 412) is described with regards to the similar step of processes 300A-300D.

‎In certain embodiments, one, multiple, and/or all steps of process 400; such as the selecting of the multiple combinations of PID constant values (step 404), the measuring of the synchronization time and master offset time of each combination of PID constant values (step 406), the selection/identification of the preferred combination of PID constant values (step 408), and/or the setting/implementing of the preferred combination of PID constant values in the PID controller (step 412); can be automatically or manually triggered upon startup of the system and/or in response to an event that may change the master offset time and/or synchronization time.

FIG. 5 is a block diagram schematic of an example device; such as slave device 102, master device 104, edge device 114, and/or cloud/remote device 112; having auto-tuner 106. Auto-tuner 106 can have various components and/or capabilities to perform the functionalities described in this disclosure regarding the auto-tuning of a PID controller within a slave device by identifying a combination of PID constant values that results in an acceptable synchronization time and/or master offset time. Auto-tuner 106, as shown in FIG. 5, can include processor 502, storage media 504, input/output interface 506, and/or user interface 510. Each auto-tuner 106 can function with and/or further include other components not expressly disclosed herein. FIG. 5 shows, and the corresponding description discloses, hardware and/or software components as an illustrative example of general hardware and/or software systems for performing the capabilities described herein. The components presented in FIG. 5 can be omitted or replaced with analogous hardware and/or software in different architectures without departing from the scope and spirit of the present disclosure. Further, auto-tuner 106 can be contained and/or the functionalities described herein can be performed partially and/or entirely in a digital/electronic environment.

The components of auto-tuner 106 shown in FIG. 5 can each be a discrete assembly or be combined with one or more components of device 102, 104, 112, and/or 114 capable of individually or collectively implementing the functionalities described herein. In some examples, the components of auto-tuner 106 can be implemented as a plurality of discrete circuitry subassemblies. In some examples, one, multiple, or all components of auto-tuner 106 can be considered to form a single computing device even when distributed across multiple component computing devices. The components of auto-tuner 106 and/or devices 102, 104, 112, and/or 114 can include a configuration in which one, multiple, or all of the functionalities described herein are performed by different components. Each auto-tuner 106 can be used to perform all or a portion of the procedures and/or processes described in this disclosure.

Each auto-tuner 106 described herein can include and/or function in conjunction with one or more computer/data processors 502. As described herein, processor 502 can be one or multiple processors used by auto-tuner 106. Multiple processors 502 can have the same or differing configurations, capabilities, etc. with one or multiple processors 502 configured to function in conjunction with one another and/or function independently. In general, processor 502 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 502 can perform instructions stored within storage media 504 associated with each auto-tuner 106 and/or stored elsewhere, and/or each processor 502 can include memory such that each processor 502 is able to store instructions and perform the functions described herein. Additionally, each processor 502 can perform other computing processes, tasks, and/or instructions described herein.

Each auto-tuner 106 (and/or collectively multiple auto-tuners 106) can also include and/or function in conjunction with one or multiple storage media 504. As described herein, storage media 504 can be one or multiple storage media having the same or differing configurations, capabilities, etc. configured to function in conjunction with one another and/or function independently. For example, storage media 504 can be, include, and/or function in conjunction with one or multiple processors 502, APIs 108, PID controllers 110, and/or other components. In another example, storage media 504 can store the multiple combinations of PID constant values, the preferred combinations of PID constant values, any designated threshold values, any step values as specified by a user, and/or other information and/or selections. Storage media 504 is configured to store other information (such as instructions, settings, designations, and/or data) and, in some examples, can be described as a computer-readable storage medium, media, and/or memory. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage media 504 is temporary memory. As used herein, a temporary memory refers to a memory having a primary purpose that is not long-term storage. Storage media 504, in some examples, is described as volatile memory. As used herein, a volatile memory refers to a memory that does not maintain stored contents when power to the storage media is turned off. Examples of volatile memories can include random access memories (RAM), dynamic random-access memories (DRAM), static random-access memories (SRAM), and other forms of volatile memories. In some examples, storage media 504 is used to store program instructions for execution by processor 502. Storage media 504, in one example, is used by software or applications running on and/or in conjunction with each auto-tuner 106 to temporarily store information during program execution.

Storage media 504 can be configured to store larger amounts of information than volatile memory and can further be configured for long-term storage of information. In some examples, storage media 504 include non-volatile storage elements. Examples of such non-volatile storage elements can include, for example, magnetic hard discs, optical discs, floppy discs, flash memories, cloud storage media, or forms of electrically programmable memories (EPROM) or electrically erasable and programmable (EEPROM) memories. Additionally, storage media 504 can be digital/electronic storage in the “cloud” that are distant from auto-tuner 106.

Each auto-tuner 106 can include one or multiple input/output interfaces 506 configured to communicate (e.g., send and/or receive information) with external component 508. The information communicated via interface 506 can be, for example, master offset time 105, instructions as to the triggering of auto-tuning by auto-tuner 106, combinations of PID constant values, and/or other information. Input/output interface 506 can ‎include an interface and/or conductors to couple to one or more internal components of auto-tuner 106 and/or external components 508.‎

Each auto-tuner 106 can also include and/or function in conjunction with one or more user interfaces 510. As described herein, each user interface 510 can be one or multiple interfaces used by one, multiple, or all components of auto-tuner 106 (as well as other components described herein). Devices 102, 104, 112, and/or 114 can each include auto-tuner 105 that includes one user interface 510, or multiple or all auto-tuners 106 can share one user interface 510, such as a user interface hosted and/or accessed on a user workstation. User interface 510 can include multiple user interfaces that have the same or differing configurations, capabilities, etc. with user interfaces 510 configured to function in conjunction with one another and/or function independently. User interface 510 can be an input and/or output device and enable user to designate the threshold values, select the combinations of PID constant values, trigger the auto-tuning/testing, and/or perform other tasks as well as view any relevant information (e.g., the results from the tests of the multiple combinations of PID constant values). For example, user interface 510 can be configured to receive inputs, such as the selection/setting of the preferred combination of PID constant values. User interface 510 can include one or more of a sound card, a video graphics card, a speaker, a display device (e.g., a liquid crystal display (LCD), a light emitting diode (LED) display, an organic light emitting diode (OLED) display, etc.), a touchscreen, a keyboard, a mouse, a joystick, and/or other type of device for facilitating input and/or output of information in a form understandable to users and/or machines. In one example, a user, operator, and/or other individual can use user interface 510 to view and/or alter any of the information associated with system 202, PID controller 110, and/or auto-tuner 106.

Process 400 and user interface 510 and/or the other systems and processes described herein can include displaying and/or otherwise providing graphs (such as graphs 600A-600C shown in FIGS. 6A-6C) in real time (e.g., live) while the auto-tuning of the combinations of PID constant values is occurring. Additionally and/or alternatively, other information can be displayed and/or provided in real time. For example, the following statistics can be displayed and/or otherwise provided in real time: the currently tested combination of PID constant values with an accompanying counter/timer (counting up) representative of the length of time the corresponding combination of PID constant values have been in the test and/or the length of time the test has taken overall, the length of time taken by the PID controller to bring the master offset time to a stable level (and how long the master offset time has been at a stable level), whether the master offset time has stabilized, the master offset time minimum and maximum for all previously tested (and currently tested) combinations of PID constant values, and/or other statistics, values, and/or graphs displaying historical and/or real time information.

The display and/or otherwise providing of information in real time can follow the following example: The auto-tuning of a first combination of PID constant values begins and the following information is displayed in real time: a) the master offset time is displayed on one or multiple graphs (e.g., graphs 600A-600C); b) a counter/timer showing how long the test is taking in real time; c) a counter/timer showing how long the PID controller has taken with the first combination of PID constant values to bring the master offset time to a stable level; d) the minimum and/or maximum values of synchronization time and/or master offset time for the current test (of all combinations of PID constant values and/or of the first combination of PID constant values); and/or e) any other relevant information. Then, after achieving a stable level of the master offset time, the following information can be displayed in addition to and/or alternative to the above information: a) a counter/timer showing how long the PID controller took to reach a stable level of the master offset time (and the counter/timer continues if synchronization is lost); b) a counter/timer showing how long the master offset time has stayed at the stable level; c) a value of how long the master offset time needs to stay at a stable level for the test of the example/first combination of PID constant values to be determined/deemed finished; and/or d) displaying any of the above information (and/or other information) upon completion of the current test of the first combination of PID constant values. Then, the above display of information can be repeated and/or supplemented for the testing of a second combination of PID constant values and subsequent combinations of PID constant values with the preferred (e.g., the best) values, statistics, information, and/or PID constant values corresponding to the best values, statistics, information, etc. being displayed and/or otherwise provided during the test. Upon completion of the testing of the combinations of PID constant values, the preferred combination(s) of PID constant values (and/or associated information) can be displayed and/or otherwise provided along with any explanatory information and/or settings.

Further, process 400 and user interface 510 and/or the other systems and processes described herein can collect, display, and/or use a variety of other data, such as maximum and minimum master offset times recorded during the tests, the count representative of the oscillation of the master offset time throughout the tests, the spacing between the inflection points in the graphs/functions of the master offset time during the tests, the amplitudes and/or intensities of the maximums and minimums of the master offset time during the tests, the symmetry of the graphs/functions of the master offset time over time, and any trends that can show overall growth and/or decay of the master offset time over time. All of the statistics, information, values, and/or data can be used to allow for a user to select the most preferred combination of PID constant values and/or can be used by a computer system/processor to determine which combination of PID constant values is preferred and should be applied/implemented in the PID controller.

FIG. 5 is one example configuration of a computing system used by computing components of the industrial system that are included in any of slave devices 102 and master device 104 of TSN 100 as well as on-premises or off-premises devices or servers that host an automated auto-tuner (such as on-premises slave devices 102, master devices 104, and edge device 114 and off-premise cloud/remote device 112 shown in FIGS. 1A-1D). Additionally, all or portions of the computing components of the industrial system could be configured as software, and the components/system shown in FIG. 5 could represent such portions. The configuration in FIG. 5 is ‎only one example of a suitable system and is not intended to suggest any limitation as to the ‎scope of use or functionality of embodiments of the disclosure described herein. In one example, some or all components, capabilities, and/or functionalities of auto-tuner 106 can be provided externally to auto-tuner 106 and/or devices 102, 104, 112, and/or 114 by way of an interface and/or other methods. The configuration in FIG. 5 may be described in the general context of execution of computer system-‎‎executable instructions, such as program modules. ‎‎Generally, program modules may include routines, programs, objects, components, logic, data ‎‎structures, and so on that perform particular tasks or implement abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments, and advantages are merely illustrative and are not considered elements or limitations of the appended claims except where explicitly recited in a claim(s).

The various embodiments disclosed herein may be implemented as a system, method, or computer program product (e.g., software and/or firmware). Accordingly, aspects may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Computer program code for carrying out operations for aspects of the present disclosure may be written in any combination of one or more programming languages. Moreover, such computer program code can be executed using a single computer system or multiple computer systems communicating with one another (e.g., using a local area network (LAN), wide area network (WAN), the Internet, etc.). While various features herein are described with reference to schematics and/or flow charts, a person of ordinary skill in the art will understand that each step, feature, components, etc. can be implemented and/or otherwise performed by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) can produce a machine that can carry out one or multipole steps and/or functions specified in the disclosed schematics and/or flow charts.

FIGS. 1A-6C shown and described herein illustrate the architecture, functionality, and/or operation of possible implementations of various embodiments of the present disclosure. In this regard, each component and/or step may represent a module, segment, or portion of code with one or more executable instructions for implementing the specified logical function(s). It should also be noted that, in some alternative implementations, the functions described with regards to each component and/or step may occur out of the order noted in the figures. For example, two steps shown in succession may, in fact, be executed substantially concurrently, or the steps may sometimes be executed in a reverse order, depending upon the functionality involved. It will also be noted that each component and/or step, and combinations of components and/or steps, can be implemented by special purpose hardware-based systems that perform the specified functions.

It is to be understood that the above description is intended to be illustrative and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, this description and the accompanying drawings are to be regarded as illustrative rather than restrictive. The scope of the disclosure should, therefore, be determined with reference to the appended claims, along with the full scope of equivalents to which such claims are entitled.

### Discussion of Possibly Examples

An example method of auto-tuning, via execution of computer-readable memory encoded with instructions, at least one proportional, derivative, and integral (PID) controller corresponding to at least one slave device in a time-sensitive network to automatically synchronize a time function of the at least one slave device with a time function of a master device is disclosed herein that can include continually obtaining a master offset time representative of a difference between the time function of the at least one slave device and the time function of the master device with the time function of the at least one slave device being dependent upon the corresponding at least one PID controller and selecting, in the at least one PID controller, multiple combinations of values of a proportional constant, a derivative constant, and an integral constant. The method can further include measuring, for each combination of values of the multiple combinations of values, a synchronization time representative of an amount of time taken by the at least one PID controller to reduce the master offset time to a stable level at or below a first designated master offset time threshold; selecting, in the at least one PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically applying, in the at least one PID controller, the preferred combination of values so that the time function of the at least one PID controller corresponding to the at least one slave device is synchronized to the time function of the master device such that the master offset time is equal to or less than the first designated master offset time threshold during operation of the at least one slave device and the master device.

The method of the preceding paragraph can optionally include, additionally and/or alternatively, any one or more of the following features, configurations, steps, and/or additional components:

The method can further include that the step of selecting the preferred combination of values further comprises providing a recommendation of the preferred combination of values for the proportional constant, the derivative constant, and the integral constant for the slave device for selection by a user.

The method can further include that the user is at least one of a human operator and a first computer processor configured to automatically select the preferred combination of values dependent upon the synchronization time and master offset time corresponding to the preferred combination of values.

The method can further include that selecting the multiple combinations of values of the proportional constant, the derivative constant, and the integral constant comprises adjusting the value of the proportional constant by a first step value to generate a first combination of values of the multiple combinations of values, adjusting the value of the derivative constant by a second step value to generate a second combination of values of the multiple combinations of values, and adjusting the value of the integral constant by a third step value to generate a third combination of values of the multiple combinations of values.

The method can further include that the first step value, the second step value, and the third step value are different values.

The method can further include that the first step value, the second step value, and the third step value are user selectable.

The method can further include that the at least one slave device and the master device use a generalized Precision Time Protocol (gPTP).

The method can further include that the first designated master offset time threshold is ten (10) nanoseconds.

The method can further include that selecting the multiple combinations of values of the proportional constant, the derivative constant, and the integral constant comprises at least one of the following: a strategy configuration table, a Ziegler-Nichols tuning method, an Astrom-Hagglund tuning method, and a Cohen-Coon tuning method.

The method can further include that selecting the multiple combinations of values of the proportional constant, the derivative constant, and the integral constant further comprises: a) setting the value of the proportional constant to one (1) and the values of the derivative constant and the integral constant to zero (0); b) increasing the value of the proportional constant by a step value to generate combinations of values while measuring, for each combination of values, the synchronization time until a value of the proportional constant renders a combination of values that results in a synchronization time that is greater than a second designated synchronization time threshold; c) resetting the value of the proportional constant to one (1); d) decreasing the value of the proportional constant by the step value to generate combinations of values while measuring, for each combination of values, the synchronization time until the value of the proportional constant is zero (0) or a value of the proportional constant renders a combination of values that results in a synchronization time that is greater than the second designated synchronization time threshold; e) setting the value of the proportional constant to a preferred proportional constant value that rendered the fastest synchronization time while the master offset time is at the smallest amount of time when at a stable level; f) repeating steps b through d to adjust the value of the derivative constant with the value of the proportional constant set at the preferred proportional constant value, the value of the derivative constant initially being set to one (1), and the value of the integral constant being set at zero (0); g) setting the value of the derivative constant to a preferred derivative constant value that rendered the fastest synchronization time while the master offset time is at the smallest amount of time when at a stable level; h) repeating steps b through d to adjust a value of the integral constant with the value of the proportional constant set at the preferred proportional constant value, the value of the derivative constant set at the preferred derivative constant value, and the value of the integral constant initially being set to one (1); and i) setting the value of the integral constant to a preferred integral constant value that rendered the fastest synchronization time while the master offset time is the smallest amount of time when at a stable level such that the preferred proportional constant value, the preferred derivative constant value, and the preferred integral constant value form the preferred combination of values that corresponds to the synchronization time that is equal to or less than the first designated synchronization time threshold and the master offset time at a stable level that is equal to or less than the first designated master offset time threshold.

The method can further include that at least one of: the first designated master offset time threshold is the same value as the second designated master offset time threshold and the second designated synchronization time is five (5) minutes.

The method can further include that the auto-tuning of the at least one PID controller is performed by an auto-tuner that is incorporated into the at least one slave device.

The method can further include automatically triggering the performance of the auto-tuning of the at least one PID controller corresponding to the at least one slave device upon startup of at least one of the following: the at least one slave device, the master device, and the time-sensitive network.

The method can further include automatically triggering the performance of the auto-tuning of the at least one PID controller corresponding to the at least one slave device upon the occurrence of at least one of the following events: a communication disruption between the at least one slave device and the master device; a disturbance of at least one of the at least one slave device, the master device, and time-sensitive network; a change in topology of the time-sensitive network; a change in hardware, firmware, or software of at least one of the at least one slave device, the master device, and the time-sensitive network; the detection of the loss of synchronization between the time function of the master device and the time function of the at least one slave device; and/or a detection of the master offset time ceasing to be at a stable level or the master offset time being greater than the first designated master offset time threshold for a designated duration of time

The method can further include that the auto-tuning of the at least one PID controller corresponding to the at least one slave device is performed by at least one of the following: the master device, an edge device, and a second computer processor remote from the at least one slave device and the master device.

An example system for auto-tuning a time function of a proportional, derivative, and integral (PID) controller of a slave device to synchronize with a time function of a master device is disclosed herein that includes the PID controller of the slave device that uses the time function that is dependent upon a combination of values of a proportional constant, a derivative constant, and an integral constant of the PID controller; the master device is in communication with the slave device and comprising the time function of the master device; and an auto-tuner in communication with the master device and the slave device with the auto-tuner having at least one computer processor and executable computer-readable instructions. The auto-tuner can be configured to continually obtain a master offset time representative of a difference between the time function of the slave device and the time function of the master device; select, in the PID controller, multiple combinations of values of the proportional constant, the derivative constant, and the integral constant; measure, for each combination of values of the multiple combinations of values, a synchronization time representative of an amount of time taken by the PID controller to reduce the master offset time to a stable level at or below a first designated master offset time threshold; select, for the PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically apply, in the PID controller, the preferred combination of values so that the time function of the PID controller corresponding to the slave device is synchronized to the time function of the master device such that the master offset time is equal to or less than the first designated master offset time threshold during operation of the slave device and the master device.

The system of the preceding paragraph can optionally include, additionally and/or alternatively, any one or more of the following features, configurations, steps, and/or additional components:

The system can further include an interface associated with the auto-tuner and configured to provide, for selection of the preferred combination of values by a user, at least one of the multiple combinations of values with the corresponding measurements of the synchronization time and a recommendation of the preferred combination of values.

The system can further include that the user is at least one of a human operator configured to manually select the preferred combination of values and the auto-tuner configured to automatically select the preferred combination of values dependent upon the synchronization time and the master offset time corresponding to the preferred combination of values.

The system can further include that the auto-tuner is incorporated into the slave device.

The system can further include that the auto-tuner uses at least one of the following to select the multiple combinations of values of the proportional constant, the derivative constant, and the integral constant: a strategy configuration table, a Ziegler-Nichols tuning method, an Astrom-Hagglund tuning method, and a Cohen-Coon tuning method.

1. A method of auto-tuning, via execution of computer-readable memory encoded with instructions, at least one proportional, derivative, and integral (PID) controller corresponding to at least one slave device in a time-sensitive network to automatically synchronize a time function of the at least one slave device with a time function of a master device, the method comprising: continually obtaining a master offset time representative of a difference between the time function of the at least one slave device and the time function of the master device with the time function of the at least one slave device being dependent upon the corresponding at least one PID controller; selecting, in the at least one PID controller, multiple combinations of values of a proportional constant, a derivative constant, and an integral constant; measuring, for each combination of values of the multiple combinations of values, a synchronization time representative of an amount of time taken by the at least one PID controller to reduce the master offset time to a stable level at or below a first designated master offset time threshold; selecting, in the at least one PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically applying, in the at least one PID controller, the preferred combination of values so that the time function of the at least one PID controller corresponding to the at least one slave device is synchronized to the time function of the master device such that the master offset time is equal to or less than the first designated master offset time threshold during operation of the at least one slave device and the master device.

2. The method of claim 1, wherein the step of selecting the preferred combination of values further comprises:
providing a recommendation of the preferred combination of values for the proportional constant, the derivative constant, and the integral constant for the slave device for selection by a user.

3. The method of claim 2, wherein the user is at least one of a human operator and a first computer processor configured to automatically select the preferred combination of values dependent upon the synchronization time and master offset time corresponding to the preferred combination of values.

4. The method of claim 1, wherein selecting the multiple combinations of values of the proportional constant, the derivative constant, and the integral constant comprises:adjusting the value of the proportional constant by a first step value to generate a first combination of values of the multiple combinations of values;adjusting the value of the derivative constant by a second step value to generate a second combination of values of the multiple combinations of values; andadjusting the value of the integral constant by a third step value to generate a third combination of values of the multiple combinations of values.

5. The method of claim 4, wherein the first step value, the second step value, and the third step value are different values.

6. The method of claim 4, wherein the first step value, the second step value, and the third step value are user selectable.

7. The method of claim 1, wherein the at least one slave device and the master device use a generalized Precision Time Protocol (gPTP).

8. The method of claim 7, wherein the first designated master offset time threshold is ten (10) nanoseconds.

9. The method of claim 1, wherein selecting the multiple combinations of values of the proportional constant, the derivative constant, and the integral constant comprises at least one of the following: a strategy configuration table, a Ziegler-Nichols tuning method, an Astrom- Hagglund tuning method, and a Cohen-Coon tuning method.

10. The method of claim 1, wherein selecting the multiple combinations of values of the proportional constant, the derivative constant, and the integral constant further comprises:a) setting the value of the proportional constant to one (1) and the values of the derivative constant and the integral constant to zero (0);b) increasing the value of the proportional constant by a step value to generate combinations of values while measuring, for each combination of values, the synchronization time until a value of the proportional constant renders a combination of values that results in a synchronization time that is greater than a second designated synchronization time threshold;c) resetting the value of the proportional constant to one (1);d) decreasing the value of the proportional constant by the step value to generate combinations of values while measuring, for each combination of values, the synchronization time until the value of the proportional constant is zero (0) or a value of the proportional constant renders a combination of values that results in a synchronization time that is greater than the second designated synchronization time threshold;e) setting the value of the proportional constant to a preferred proportional constant value that rendered the fastest synchronization time while the master offset time is at the smallest amount of time when at a stable level;f) repeating steps b through d to adjust the value of the derivative constant with the value of the proportional constant set at the preferred proportional constant value, the value of the derivative constant initially being set to one (1), and the value of the integral constant being set at zero (0);g) setting the value of the derivative constant to a preferred derivative constant value that rendered the fastest synchronization time while the master offset time is at the smallest amount of time when at a stable level;
h) repeating steps b through d to adjust a value of the integral constant with the value of the proportional constant set at the preferred proportional constant value, the value of the derivative constant set at the preferred derivative constant value, and the value of the integral constant initially being set to one (1); and
i) setting the value of the integral constant to a preferred integral constant value that rendered the fastest synchronization time while the master offset time is the smallest amount of time when at a stable level such that the preferred proportional constant value, the preferred derivative constant value, and the preferred integral constant value form the preferred combination of values that corresponds to the synchronization time that is equal to or less than the first designated synchronization time threshold and the master offset time at a stable level that is equal to or less than the first designated master offset time threshold.

11. The method of claim 10, wherein at least one of: the first designated master offset time threshold is the same value as the second designated master offset time threshold and the second designated synchronization time is five (5) minutes.

12. The method of claim 1, wherein the auto-tuning of the at least one PID controller is performed by an auto-tuner that is incorporated into the at least one slave device.

13. The method of claim 1, further comprising:automatically triggering the performance of the auto-tuning of the at least one PID controller corresponding to the at least one slave device upon startup of at least one of the following: the at least one slave device, the master device, and the time- sensitive network.

14. The method of claim 1, further comprising:automatically triggering the performance of the auto-tuning of the at least one PID controller corresponding to the at least one slave device upon the occurrence of at least one of the following events:
a communication disruption between the at least one slave device and the master device;
a disturbance of at least one of the at least one slave device, the master device, and time-sensitive network;
a change in topology of the time-sensitive network;
a change in hardware, firmware, or software of at least one of the at least one slave device, the master device, and the time-sensitive network; and a detection of the master offset time ceasing to be at a stable level or the master offset time being greater than the first designated master offset time threshold for a designated duration of time.

15. The method of claim 1, wherein the auto-tuning of the at least one PID controller corresponding to the at least one slave device is performed by at least one of the following: the master device, an edge device, and a second computer processor remote from the at least one slave device and the master device.

16. A system for auto-tuning a time function of a proportional, derivative, and integral (PID) controller of a slave device to synchronize with a time function of a master device, the system comprising:the PID controller of the slave device that uses the time function that is dependent upon a combination of values of a proportional constant, a derivative constant, and an integral constant of the PID controller;the master device in communication with the slave device and comprising the time function of the master device; andan auto-tuner in communication with the master device and the slave device, the auto-tuner having at least one computer processor and executable computer-readable instructions configured to:continually obtain a master offset time representative of a difference between the time function of the slave device and the time function of the master device;select, in the PID controller, multiple combinations of values of the proportional constant, the derivative constant, and the integral constant;
measure, for each combination of values of the multiple combinations of values, a synchronization time representative of an amount of time taken by the PID controller to reduce the master offset time to a stable level at or below a first designated master offset time threshold;
select, for the PID controller, a preferred combination of values from the multiple combinations of values that corresponds to the synchronization time that is equal to or less than a first designated synchronization time threshold and the master offset time at a stable level that is equal to or less than the first designated master offset time threshold; and automatically apply, in the PID controller, the preferred combination of values so that the time function of the PID controller corresponding to the slave device is synchronized to the time function of the master device such that the master offset time is equal to or less than the first designated master offset time threshold during operation of the slave device and the master device.

17. The system of claim 16, further comprising:an interface associated with the auto-tuner and configured to provide, for selection of the preferred combination of values by a user, at least one of the multiple combinations of values with the corresponding measurements of the synchronization time and a recommendation of the preferred combination of values.

18. The system of claim 17, wherein the user is at least one of a human operator configured to manually select the preferred combination of values and the auto-tuner configured to automatically select the preferred combination of values dependent upon the synchronization time and the master offset time corresponding to the preferred combination of values.

19. The system of claim 16, wherein the auto-tuner is incorporated into the slave device.

20. The system of claim 16, wherein the auto-tuner uses at least one of the following to select the multiple combinations of values of the proportional constant, the derivative constant, and the
integral constant: a strategy configuration table, a Ziegler-Nichols tuning method, an Astrom- Hagglund tuning method, and a Cohen-Coon tuning method.
